(19) United States
(12) Patent Application Publication
(10) Pub. No.: US 2002/0015059 A1
(43) Pub. Date: Feb. 7, 2002

(54) Method and system for publishing reports to a network

(76) Inventor: Hernan Jose Clarke, Scottsdale, AZ (US)

Correspondence Address: Alexander B. Ching, Quarles & Brady Streich Lang, LLP, Two North Center Avenue, Renaissance One, Phoenix, AZ, 85004-2391, US

(21) Appl. No.: 09/837,796

(22) Filed: Apr. 17, 2001

Related U.S. Application Data
(60) Provisional application No. 60/197,475, filed on Apr. 17, 2000.

(51) Int. Cl. G09G 5/00

(52) U.S. Cl. 345/744

(57) ABSTRACT

A method and system for publishing reports to a network is disclosed. In the first step of the method a report template area is initialized. Then report components are added to the template area. The report components are customized. Next, a format for publishing the report is chosen. Finally, the converted report is sent to a database for storage and future retrieval.

### BACKGROUND OF INVENTION

The rise in the use of computer applications running on a server and accessible by clients connected to a local area network, wide area network or the Internet has lead to greater collaboration and sharing of information. In these systems, clients access a remote server that is running the application and can use the application without having to load a copy on to individual computers. Multiple clients can access the application and share information generated by other users.

One drawback to these systems is that they lack an easy and efficient way to gather the information into a report and then post that report in such a way that others can easily access and view. Many applications lack report generations, others force the user to save the report in a proprietary format that has to be downloaded to an individual computer and read using costly proprietary software. What is needed is an easy way to quickly generate a report and publish them top a server in such a way that they can be read by anyone using industry standard software.

### SUMMARY OF THE INVENTION

In accordance with the teachings of the present inventions, a method and system for publishing reports to a network is disclosed. The method and system of the present invention provides advantage over previously developed report generation techniques techniques.

In one embodiment, a method and system for publishing reports to a network is disclosed. In the first step of the method a report template area is initialized. Then report components are added to the template area. The report components are customized. Next, a format for publishing the report is chosen. Finally, the converted report is sent to a database for storage and future retrieval.

A technical advantage of the present system is that reports can be quickly generated by a user at a client computer and published to a web server with minimal efforts. Additional technical advantages can be readily apparent from the following figures, description and claims.

### BRIEF DESCRIPTION OF THE DRAWINGS

For a more complete understanding of the present invention and advantages thereof, reference is now made to the following descriptions, taken in conjunction with the following drawings, in which like reference numerals represent like parts, and in which:

FIG. 1 is a block diagram of a computer network system;

FIG. 2 is a flowchart illustrating the form of a report;

FIG. 3 is a screen shot illustrating a report template;

FIG. 4 is a screen shot illustrating a customized template; and

FIG. 5 is a flowchart illustrating the publishing of a report.

### DETAILED DESCRIPTION OF THE DRAWINGS

Turning first to the nomenclature of the specification, the detailed description which follows is represented largely in terms of processes and symbolic representations of operations by conventional computer components, including a central processing unit (“CPU”) or processor associated with a general purpose computer system, memory storage devices for the CPU, and connected pixel-oriented display devices. These operations include the manipulation of data bits by the CPU and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process or method is generally considered to be a sequence of computer-executed steps leading to a desired result. These steps generally require manipulations of physical quantities. Usually, although not necessarily, these quantities take the form of electrical, magnetic, or optical signals capable of being stored, transferred, combined, compared or otherwise manipulated. It is conventional for those skilled in the art to refer to these signals as bits, values, elements, symbols, characters, text, terms, numbers, records, files, or the like. It should be kept in mind, however, that these and others should be associated with appropriate physical quantities for computer operations, and that these terms are merely conventional labels applied to physical quantities that exist within and during operation of the computer.

In addition, it should be understood that the programs, processes, methods, etc. described herein are but an example of one implementation of the present invention and are not related or limited to any particular computer, apparatus or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

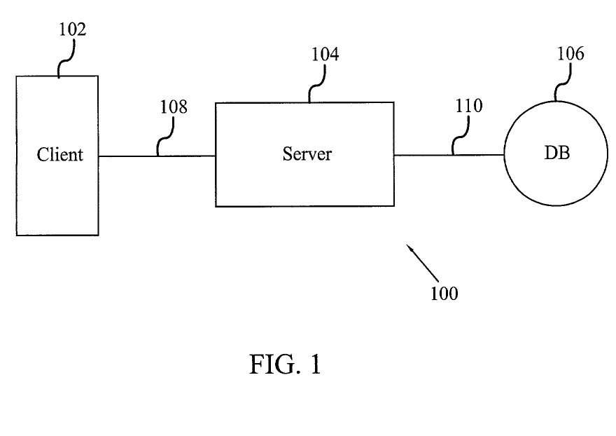

Referring now in more detail to the drawings, FIG. 1 is a diagram illustrating a report generating system 100 including at least one client computer 102, a remote server 104 and remote database 106. Report generating system 100 includes the interface between remote server 104 and at least one client computer 102. For example, report-generating system 100 includes an interconnection between client computer 102 and remote server 104 through a communication line 108. Computer network 100 also includes the interface between remote server 104 and remote database 106 (not illustrated) through a plurality of communication lines 110. This allows client computer 102 to access content stored on the remote database 106 via remote server 104. While FIG. 1 shows only one client computer 102, other clients can also be interconnected with remote server 104. In one embodiment, the present invention is a multi-tier system with the client computer operating as the first tier, the remote computer the middle tier and the remote storage is the third tier. The middle tier serves the application to the first tier which typically access the middle tier using a web browser. This way, the first tier does not need to install the report generation and publishing software, saving time and effort.

Remote server 104 is a computer such as a personal computer, file server, workstation, minicomputer, mainframe, or any other computer capable of communicating and interconnecting with other computers. Remote server 104 may include a processor, a printer, an input device such as a mouse and/or a keyboard, a monitor, a floppy disk drive, memory, a modem, and a mass storage device such as a hard disk drive. Communication lines 110 and communication lines 108 may be any type of communication link capable of supporting data transfer. For example, these communication lines may include any combination of an Integrated Services Digital Network (“ISDN”) communication line, a hard-wired line, a telephone link, a digital subscriber line, a cable connection, a fiber optic link or a wireless connection.

Client computer 102 may be similar to remote server 104 and may be implemented using virtually any type of computer. Client computer 102 may be a personal computer having a processor, a printer, an input device such as a mouse and/or a keyboard, a monitor, a floppy disk drive, memory, a modem, and a mass storage device such as a hard disk drive. Client computer 102 and remote server 104 will be operating under the control of an operating system such as MS-DOS, Macintosh OS, WINDOWS NT, WINDOWS 95/98/2000, OS/2, UNIX, XENIX, LINUX, BEOS and the like. Client computer 102 and remote server 104 each may utilize a different operating system. Client computer 102 and remote server 104 may execute any number of available application programs such as a web browser or web server.

Client computer 102 may communicate through server 104 using the Internet. For example, in the case where remote server 104 is configured as a web server, client computer 102, generally using a web browser application program, may couple to remote server 104 and provide the address or uniform resource locator (URL) of an Internet web page. Remote server 104 in response transmits the Internet web page back to client computer 102 using a web browser.

Remote Storage 106 is a storage medium such as an array of hard disk drives, read/rewritable optical drives and the like operable to store data for later retrieval. Remote storage 106 may be co-located with remote server 104 are located across a network.

In operation, client computer 102 is running a web browser program to access a web site serviced by remote server 104. In one embodiment, remote server 104 is a middle tier running an application. Client computer 102 accesses the application using a web browser or similar program. Client computer 102 accesses the remote computer, which in turn provides information screens or web pages to the client computer 102. The user of the client computer 102 enters information in the appropriate places on the web pages and that information is sent to the remote computer 104. Remote computer 104 processes the information and can send the results back to the client computer 102 as web pages. Thus the web pages serve as an interface for the application that is actually running on remote server 104. The application, in the present invention, includes a report generation and publishing function. The user of client computer 102 is able to access and use the application using client computer 102. To generate and publish a report, client computer 102 can access the portion of the application that controls the report generation portion of the application, and, through the use of informational screens supplied by remote server 104, generate a report. Remote database 106 can store both the report and data used to build the report.

Although network interconnection 100 has been illustrated and described in FIG. 1 as being a node or interconnection on the Internet, network interconnection 100 may be any interconnection found on any computer network such as a local area network (“LAN”), a wide area network (“WAN”), an intranet, such as a corporate intranet, or any other communications and data exchange system created by connecting two or more computers. The present invention will be illustrated and described with an implementation using the Internet, however, it should be understood that the present invention is not limited to only implementations using the Internet.

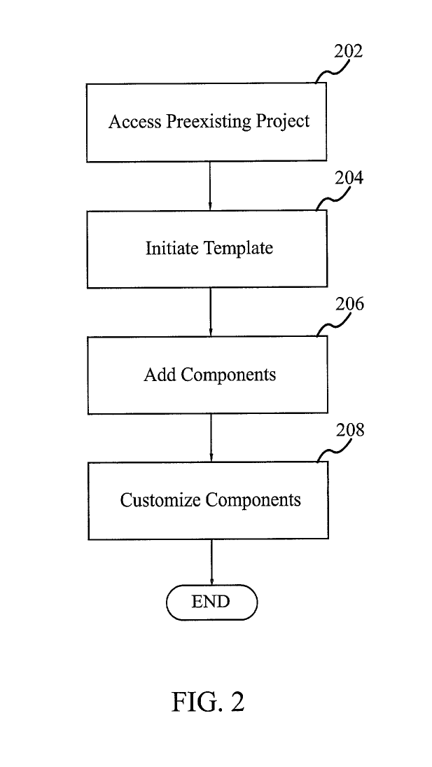

FIG. 2 is a flowchart illustrating the report generation process in accordance with the teachings of the present invention. In step 202, a pre-existing project is accessed by a user. The pre-existing project can be any type of project capable of being produced by any type of application running on remote server 104. In one embodiment, remote server 104 is running a planning/scheduling application and the user is accessing a pre-existing project involving one or more scheduling tasks.

In step 204, an initial template area is initialized. The template area is where the report will be assembled as a collection of report components.

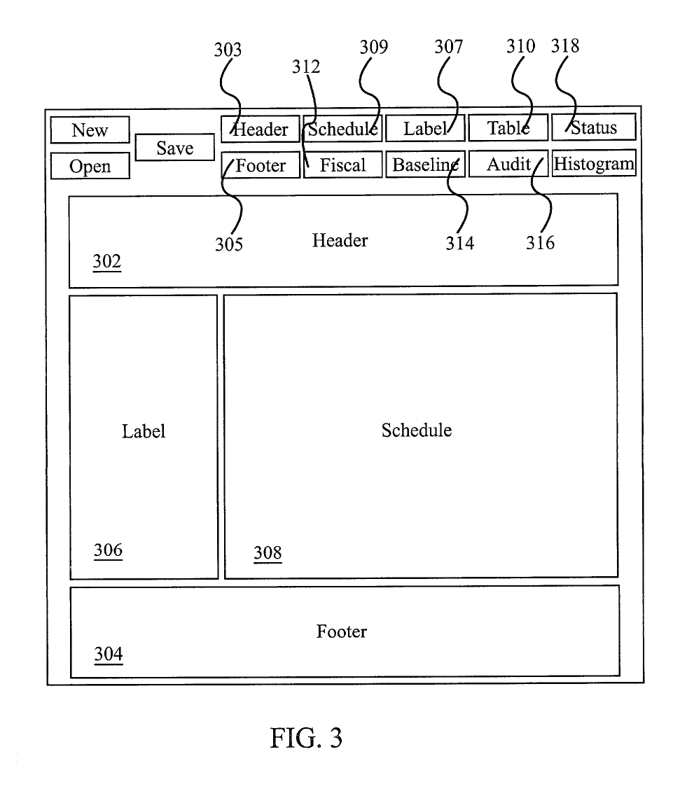

In step 206, the report components are added to initial template area. FIG. 3 illustrates an exemplary template area with report components. FIG. 3 shows a header component 302 chosen for the template by selecting header button 303, a footer component 304 chosen form the template by selecting footer button 305, a label component 306 chosen for the template by selecting label button 307, a schedule component 308 chosen for the template by selecting schedule button 309. Other components can also be selected for the template. For example, they can be a table component button 310, a fiscal component button 312, a baseline component button 314, an audit component button 316, a status component button 318 and a histogram component button 320. In the embodiment where the application is a planning program, header component 302 may contain information such as title, date and author. Footer component 304 may be used to display information such as title, page number, a legend for any graph displayed and the like. Schedule component 306 may include graphical representation of a schedule. Label component 308 may include textual information regarding planning. Table component 310 allows the user to quickly outline tables with the columns based on parameters selected by the user from a predefined list. Fiscal component 312 produces a special table that show project parameters over a certain period of time, such as a quarter. Baseline component 314 allows for the illustration of trends and comparisons by showing planning parameters compared to some baseline. Audit component 316 shows planning parameters as they exist at the end of a project. Status component 318 shows planning parameters as they exist at some point in the project. Histogram component 320 displays a histogram of planning parameters. Each component can be individually sized depending on the needs of the user. Also, components such as header component 302 and footer component 304 can automatically size themselves to fit into the template area. Other than the header and footer components 302 and 304, the other components can appear on any part of the report. These components are shown for illustrative purposes and the actual components needed by a particular report generation system will vary.

Turning back to FIG. 2, in step 208, the individual component areas can be customized by entering text into the components. This can be done, in one embodiment by double clicking on a component area, which will initiate a text entry area. Also, by double clicking in certain components, such as the schedule component, graphical or tabular information regarding the project can be retrieved and placed in a component. For example, a pre-existing schedule can be selected and displayed in schedule components.

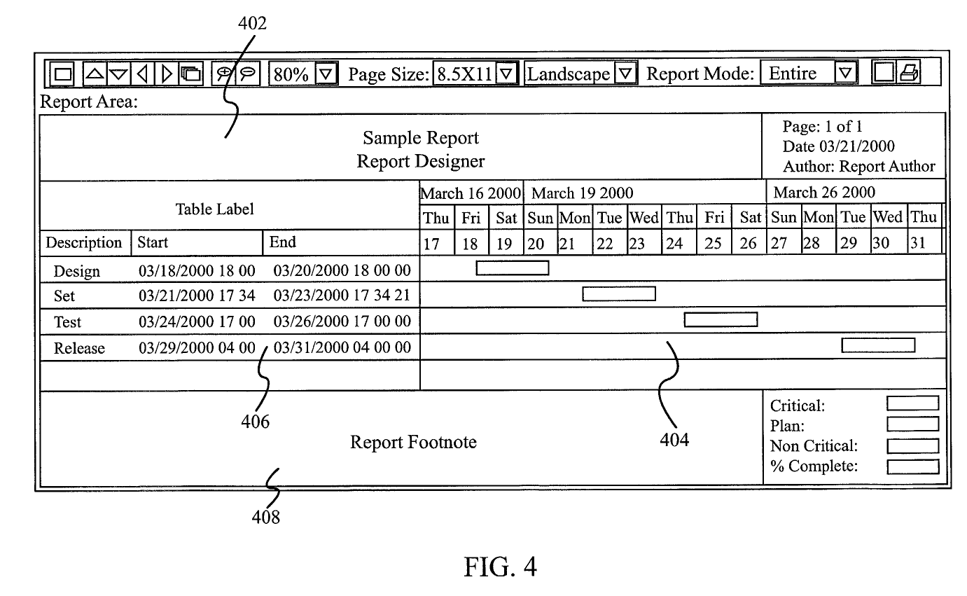

FIG. 4 is a screen shot of a report view screen showing a customized template. A customized header 402 indicates the title of the report. Footnotes can be added to customized footer 408. Customize schedule 404 displays a pre-existing schedule for a specific project. Customized label 406 includes tabular information regarding the same project.

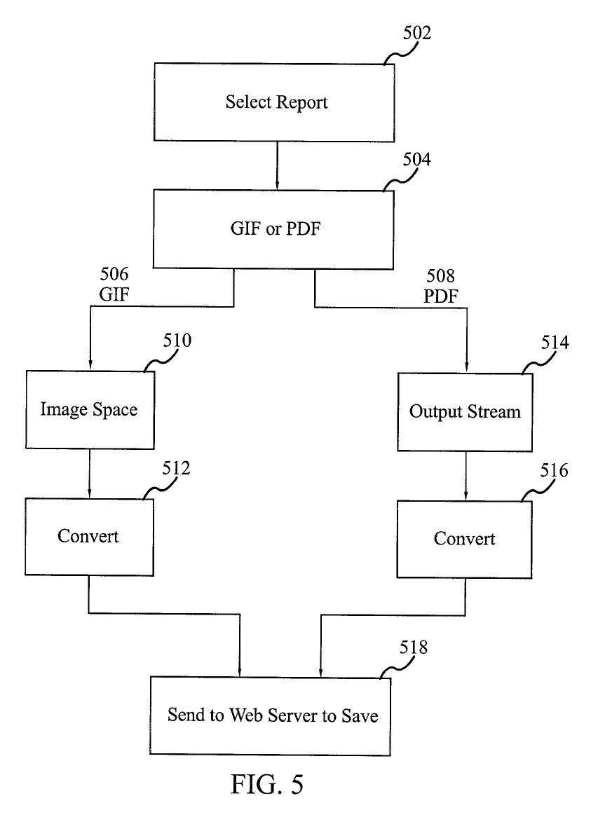

FIG. 5 is a flowchart illustrating the publishing of a finished report to a web server for future viewing. In step 502, the user selects an existing report to publish. In step 504, the user selects what format to publish the report in. In one embodiment, the user may be requested to choose a .gif format in step 506 or a .pdf format in step 508. A .gif file is a standard graphical file type and a pdf file is a standard file structure for viewing documents on the Internet that was developed by Adobe Corporation of California. While this flowchart illustrates the use of gif and .pdf formats, other graphical and textual formats can be used such as tiff or the like. If the user chooses the gif format, in step 506 the client computer creates an image space in memory for the report in step 510 and a .gif graphic of the report is created in step 512, as is well known in the art.

If the user chooses a .pdf format, an output stream of the report is created in step 514 and a .pdf graphic is created in step 516, as is well known in the art.

After step 512 or 516, depending on the format chosen, the converted report is sent to a web server, such as remote server 104 in the requested format. The report is then stored in remote database 106, with the remote server storing information on how to retrieve the report in step 518. Remote database can also be a remote file system. Other users may then access the web server to recall the published report and view it.

While the invention has been particularly shown and described in the foregoing detailed description, it will be understood by those skilled in the art that various other changes in form and detail may be made without departing from the spirit and scope of the invention.

1. A method for publishing report for display by a web browser comprising:
initializing a report template area;
adding report components to the template area;
customizing the report components by selecting pre-existing graphical, textual, tabular and/or other information for display in the report;
choosing a format for publishing the report;
converting the report to the chosen format;
sending and storing the converted report to a database; and
allowing access to the report by displaying the report using the format chosen on a client computer access a web server using a web browser.
